(19) United States
(12) Patent Application Publication
(10) Pub. No.: US 2011/0112248 A1
(43) Pub. Date: May 12, 2011

(54) METHOD FOR THE PRODUCTION OF POLYVINYL ACETALS HAVING A LOW RESIDUAL ALDEHYDE CONTENT IN WASTE WATER

(75) Inventor: Bernd Papenfuhs, Obertshausen (DE)

(73) Assignee: KURARAY EUROPE GMBH, Frankfurt am Main (DE)

(21) Appl. No.: 12/675,292

(22) PCT Filed: Sep. 5, 2007
(86) PCT No.: PCT/EP2007/059285

§ 371 Date: Feb. 25, 2010

(51) Int. Cl. C08F 8/00

(52) U.S. Cl. 525/61

(57) ABSTRACT

Aldehyde content of the waste water from polyvinylacetal production from polyvinyl alcohols is reduced by acetalizing a portion of total polyvinyl alcohol, and after precipitation of polyvinyl acetal, adding a further portion of polyvinyl alcohol.

The present invention relates to a method for the production of polyvinyl acetals having a reduced residual aldehyde content in the resulting waste water.

### TECHNICAL FIELD

In the production of polyvinyl acetals by reaction of polyvinyl alcohols with aldehydes, the reaction is usually performed in an aqueous medium since the polyvinyl alcohols used are for the most part water-soluble while the target product polyvinyl acetal precipitates as a solid from this reaction medium after the reaction has taken place.

Unreacted aldehyde remains in the reaction medium or is precipitated together with polyvinyl acetal. The use of excess aldehyde is necessary in particular to obtain polyvinyl acetals having high degrees of acetalization. As a result, significant quantities of aldehyde not reacted with polyvinyl alcohol remain in the waste water of the reaction, representing an undesired waste water contamination. These waste waters have to be supplied to a waste water treatment plant for purification, which results in costs dependent on the aldehyde content thereof.

### PRIOR ART

Various variants of the method have already been discussed to obtain an aldehyde conversion that is as complete as possible in the acetalization of the polyvinyl alcohols. For example, DE 10 2004 054569 A1, DE 10 2004 054 568 A1, JP-A 2001-288215 and JP-A 2000-159831 describe methods with addition of the reactants in stages to achieve complete conversion of the aldehydes.

These methods are conducted in a complicated way involving the addition of polyvinyl alcohol, aldehyde and acid catalyst in stages, matched to a temperature profile.

### OBJECT

It was therefore the object of the present invention to provide a simple method derived from the existing methods for the production of polyvinyl acetals, with the help of which reduced waste water contamination by aldehydes can be achieved.

### PRESENTATION OF THE INVENTION

Subject matter of the present invention is a method for the production of polyvinyl acetals by the acid-catalyzed reaction of one or more polyvinyl alcohols with one or more aldehydes, the formed polyvinyl acetal precipitating from the reaction medium, characterized in that only after precipitation of the polyvinyl acetal 0.1 to 50% by weight of polyvinyl alcohol, based on the total quantity of polyvinyl alcohol used, is added.

In principle, the addition of polyvinyl alcohol after precipitation of the polyvinyl acetal according to the invention can be performed subsequent to any method for the production of polyvinyl acetals known from prior art. It is only critical that the polyvinyl acetals formed have precipitated from the reaction medium prior to further addition of polyvinyl alcohol, and the polyvinyl alcohol added afterwards is soluble in the reaction medium.

The reaction of the aldehydes remaining in the polyvinyl acetal suspension with the additionally added polyvinyl alcohol is referred to as secondary reaction below.

The quantity of polyvinyl alcohol added in the secondary reaction is based on the total quantity of polyvinyl alcohol used, i.e. the sum of the quantity of polyvinyl alcohol used in the reaction until precipitation of the polyvinyl acetal and the quantity of polyvinyl alcohol used in the secondary reaction.

The quantity of polyvinyl alcohols used in the secondary reaction is 0.1 to 50% by weight, preferably 1 to 30% by weight, and most preferably 5 to 20% by weight, of the total quantity of polyvinyl alcohols used.

Depending on the conditions of the secondary reaction according to the invention and the aldehyde amount used for it, the method according to the inventions allows for a reduction of the aldehyde content of the filtrate of the polyvinyl acetal suspension or waste water of the acetalization reaction of up to 10%, preferably up to 20%, most preferably up to 30%. The reduction of the aldehyde content according to the invention is determined from the difference of the aldehyde contents in the filtrate of the polyvinyl acetal suspension obtained with or without further addition of a partial quantity of polyvinyl alcohol.

The determination of the aldehyde content in the filtrate of the polyvinyl acetal suspension preferably occurs by gas chromatography.

In the method according to the invention it is possible that the polyvinyl alcohols used for the primary reaction with the aldehydes and the polyvinyl alcohols used after precipitation of the polyvinyl acetal (in the secondary reaction) have the same chemical composition; however, they can also have different chemical compositions.

In the method according to the invention, polyvinyl alcohols having a viscosity of 2.0 to 35.0 mPas (measured as 4.0% by weight aqueous solution according to Happier at 20° C. in accordance with DIN 53015) and/or a degree of hydrolysis of at least 80 mol %, preferably 80 to 99.8 mol %, are preferably used for the reaction with the aldehydes and/or in the secondary reaction.

For the completion of the secondary reaction it is advantageous to stir the polyvinyl acetal suspension for at least another 5 min after addition of the polyvinyl alcohol. Temperatures of at least 25° C., in particular at least 50° C. and preferably at least 70° C. can be recommended as reaction temperatures of the secondary reaction. Reaction duration and temperature of the secondary reaction depend on the molecular weight of the polyvinyl acetal and the desired reduction of the residual aldehyde content.

In a preferred embodiment of the present invention the further addition of polyvinyl alcohol occurs in the form of an aqueous solution of same.

Another preferred embodiment of the method according to the invention consists in the co-use or exclusive use of vinyl alcohol copolymers, e.g. ethylene/vinyl alcohol copolymers, as acetalization component and/or in the secondary reaction.

In the method according to the invention formaldehyde, acetaldehyde, propionaldehyde or n-butyraldehyde, each alone or as mixture, is preferably used as aldehyde, the use of n-butyraldehyde having the greatest commercial relevance.

### EXAMPLES

The following Examples 1 to 3 are provided to further explain the invention without limiting it in any form. The Comparative Example describes the production of a polyvinyl acetal according to prior art.

As polymer raw material for all Examples and the Comparative Example a polyvinyl alcohol having a content of acetyl groups of 1.0 mol %, a content of vinyl alcohol groups of 99.0 mol % and a viscosity according to Happier of 26.6 mPas (measured as 4.0% aqueous solution in accordance with DIN 53015) was used.

### Example 1

5700 g of a 10.58% aqueous polyvinyl alcohol solution was introduced into a 10 liter glass reactor and diluted with 1053 g of distilled water. Subsequently, it was heated while stirring until an internal temperature of 90° C. was reached, and then cooled. At 40° C. 363.1 g of n-butyraldehyde was added within 5 minutes, and further cooled. At 14° C. 531 ml of 20% hydrochloric acid was added dropwise within 5 minutes; 5 minutes after addition of the acid the product settled out of the reaction solution as colorless precipitate. 5 minutes after precipitation of the polyvinyl acetal 300 g of the polyvinyl alcohol solution mentioned above was added within 5 minutes. Subsequently, the suspension was heated linearly to 65° C. within 90 minutes, and maintained at this temperature for 180 minutes while stirring was continued.

Afterwards, the product precipitate was filtered, and the filtrate was analyzed with regard to its n-butyraldehyde content by means of gas chromatography.

The polyvinyl acetal obtained had a content of 20.7% by weight of vinyl alcohol units.

### Example 2

5100 g of a 10.58% aqueous polyvinyl alcohol solution was introduced into a 10 liter glass reactor and diluted with 1053 g of distilled water. Subsequently, it was heated while stirring until an internal temperature of 90° C. was reached, and then cooled. At 40° C. 363.1 g of n-butyraldehyde was added within 5 minutes, and further cooled. At 14° C. 531 ml of 20% hydrochloric acid was added dropwise within 5 minutes; 3 minutes after addition of the acid the product settled out of the reaction solution as colorless precipitate. 5 minutes after precipitation of the polyvinyl acetal 900 g of the polyvinyl alcohol solution mentioned above was added within 5 minutes. Subsequently, the suspension was heated linearly to 65° C. within 90 minutes, and maintained at this temperature for 180 minutes while stirring was continued.

Afterwards, the product precipitate was filtered, and the filtrate was analyzed with regard to its n-butyraldehyde content by means of gas chromatography.

The polyvinyl acetal obtained had a content of 20.5% by weight of vinyl alcohol units.

### Example 3

4200 g of a 10.58% aqueous polyvinyl alcohol solution was introduced into a 10 liter glass reactor and diluted with 1053 g of distilled water. Subsequently, it was heated while stirring until an internal temperature of 90° C. was reached, and then cooled. At 40° C. 363.1 g of n-butyraldehyde was added within 5 minutes, and further cooled. At 14° C. 531 ml of 20% hydrochloric acid was added dropwise within 5 minutes; immediately after addition of the acid the product settled out of the reaction solution as colorless precipitate. 5 minutes after precipitation of the polyvinyl acetal 1800 g of the polyvinyl alcohol solution mentioned above was added within 5 minutes. Subsequently, the suspension was heated linearly to 65° C. within 90 minutes, and maintained at this temperature for 180 minutes while stirring was continued.

Afterwards, the product precipitate was filtered, and the filtrate was analyzed with regard to its n-butyraldehyde content by means of gas chromatography.

The polyvinyl acetal obtained had a content of 20.5% by weight of vinyl alcohol units.

### COMPARATIVE EXAMPLE

The production of the polyvinyl acetal occurred in a manner similar to Examples 1 to 3, with the difference that the partial quantity of polyvinyl alcohol used in the Examples for the further addition according to the invention was introduced together with the chief quantity (introduction of 6000 g of aqueous polyvinyl alcohol solution).

The polyvinyl acetal obtained, the filtrate of which was analyzed with regard to its n-butyraldehyde content by means of gas chromatography, had a content of 20.8% by weight of vinyl alcohol units.

### Methods of Determination

1. Determination of the Viscosity of the Polyvinyl Alcohol Solutions

96.00+/−0.01 g of distilled water and 4.00+/−0.01 g of polyvinyl alcohol were weighed into a 250 ml Erlenmeyer flask with ground-glass stopper and completely dissolved at 50° C. in a shaking machine. Subsequently, it was cooled to 20° C., and the dynamic viscosity (DIN 53015; method according to Happier) was determined at 20° C. using a suitable ball.

2. Determination of the Acetyl Group Content of Polyvinyl Alcohols

First, a standard aqueous solution of the polyvinyl alcohol to be analyzed was subjected to an alkaline ester hydrolysis using an excess of potassium hydroxide; subsequently, the excess of KOH was back-titrated with hydrochloric acid.

3. Determination of the Vinyl Alcohol Unit Content of Polyvinyl Acetals

The content of vinyl alcohol units in the polyvinyl acetals was determined by acetalization of the hydroxyl groups with acetic anhydride in the presence of pyridine. For this, 1.500 g+/−0.001 g of polyvinyl acetal was weighed in (an appropriately greater amount with plasticizer-containing products), and 10 ml of a pyridine/acetic anhydride mixture (77:23) was added. After storage for about 14 hours of the well-sealed analysis sample at 50° C., at room temperature 25 ml of 1,2-dichloroethane and 3 ml of distilled water were added and allowed to stand for one hour. After filling the sample up to a total volume of 160 ml with distilled water it was titrated against sodium hydroxide solution with rapid stirring.

4. Determination of the N-Butyraldehyde Content of Polyvinyl Acetal Filtrates (Waste Water)

The quantification occurred by headspace GC analysis using a gas chromatograph of the type Agilent 6890 equipped with an HS sampler Combi PAL from CTC Analytics and a 60 m separation column FS-DB1 (100% dimethylpolysiloxane, carrier gas: hydrogen).

### Results

The following n-butyraldehyde contents were measured in the polyvinyl acetal filtrates or product waste waters:

Comparative Example: 1000 ppm

Example 1: 900 ppm

Example 2: 800 ppm

Example 3: 750 ppm

1.-5. (canceled)

6. A method for the production of polyvinyl acetals comprising an acid-catalyzed reacting one or more polyvinyl alcohols with a portion of one or more aldehydes, precipitating polyvinyl acetal from the reaction medium, and after precipitating polyvinyl acetal, adding to the reaction medium a remaining portion of 0.1 to 50% by weight of polyvinyl alcohol, based on the total quantity of polyvinyl alcohol used.

7. The method of claim 6, wherein the polyvinyl alcohol added after precipitating the polyvinyl acetal has a viscosity of 2.0 to 35.0 mPas measured as 4.0% by weight aqueous solution according to Floppier at 20° C. in accordance with DIN 53015.

8. The method of claim 6, wherein the polyvinyl alcohol added prior to and after precipitation of the polyvinyl acetal have the same chemical composition.

9. The method of claim 7, wherein the polyvinyl alcohol added prior to and after precipitation of the polyvinyl acetal have the same chemical composition.

10. The method of claim 6, wherein addition of the remaining portion of polyvinyl alcohol occurs in the form of an aqueous solution.

11. The method of claim 7, wherein addition of the remaining portion of polyvinyl alcohol occurs in the form of an aqueous solution.

12. The method of claim 8, wherein addition of the remaining portion of polyvinyl alcohol occurs in the form of an aqueous solution.

13. The method of claim 9, wherein addition of the remaining portion of polyvinyl alcohol occurs in the form of an aqueous solution.

14. The method of claim 6, wherein n-butyraldehyde is used as an aldehyde.
